(19) United States
(12) Patent Application Publication
(10) Pub. No.: US 2021/0088866 A1
(43) Pub. Date: Mar. 25, 2021

(54) OPTICAL MODULATOR

(71) Applicant: ELECTRONICS AND TELECOMMUNICATIONS RESEARCH INSTITUTE, Daejeon (KR)

(72) Inventors: Jin Tae KIM, Daejeon (KR); Chil Seong AH, Daejeon (KR)

(21) Appl. No.: 16/986,026

(22) Filed: Aug. 5, 2020

(30) Foreign Application Priority Data
Sep. 20, 2019 (KR) 10-2019-0116151

(51) Int. Cl. G02F 1/157; G02F 1/1524; G02F 1/01; G02F 1/1506

(52) U.S. Cl. CPC G02F 1/157; G02F 1/1524; G02F 1/1506; G02F 1/011; G02F 1/15245

(57) ABSTRACT

Provided is an optical modulator. The optical modulator includes an optical waveguide device and an electrochromic device on the optical waveguide device. The optical waveguide device includes a cladding layer and a core layer extending in a first direction on the cladding layer. The electrochromic device includes a lower electrode on the core layer, an upper electrode facing the lower electrode, an electrolyte layer between the lower electrode and the upper electrode, and an electrochromic layer between the lower electrode and the electrolyte layer.

### CROSS-REFERENCE TO RELATED APPLICATIONS

This U.S. non-provisional patent application claims priority under 35 U.S.C. § 119 of Korean Patent Application No. 10-2019-0116151, filed on Sep. 20, 2019, the entire contents of which are hereby incorporated by reference.

### BACKGROUND

The present disclosure herein relates to an optical modulator, and more particularly, to an optical modulator including an optical waveguide device and an electrochromic device.

Recently, an optical communication technology has been rapidly developed based on IT technology. In particular, since visual communication, electronic commerce, and the like have been realized with an increase in the use of the internet, it is necessary to establish high-speed broadband communication systems for transmitting massive information.

An optical communication technology may be divided into transmission, reception, and modulation fields. The modulation field is closely related to a processing speed and high-frequency characteristics of an optical signal, and thus has received increasing attention.

Mach-Zehnder modulators, which include an input waveguide, an output waveguide, and a plurality of branch waveguides between the input waveguide and the output waveguide, and thermo-optic modulators, which include a multi-mode optical fiber and a heater on the multi-mode optical fiber, are typically used as optical modulators. However, the Mach-Zehnder modulators and thermo-optic modulators have complicated structures, causing degradation of productivity of a manufacturing process.

Therefore, optical modulators having a relatively simple structure and including an optical waveguide device with high optical modulation efficiency are developed. An optical waveguide device typically includes a core, which confines light waves and minimizes optical loss in a longitudinal direction to propagate light, and cladding which surrounds the core.

In relation to typical optical modulators including optical waveguides, researches are carried out to develop optical waveguide device modulators for improving the efficiency of modulation of horizontal incident light.

### SUMMARY

The present disclosure provides an optical modulator having a relatively simple structure and enabling easy optical modulation of horizontal incident light.

An embodiment of the inventive concept provides an optical modulator including: an optical waveguide device; and an electrochromic device on the optical waveguide device, wherein the optical waveguide device includes: a cladding layer; and a core layer extending in a first direction on the cladding layer, and wherein the electrochromic device includes: a lower electrode on the core layer; an upper electrode facing the lower electrode; an electrolyte layer between the lower electrode and the upper electrode; and an electrochromic layer between the lower electrode and the electrolyte layer.

In an embodiment, the optical waveguide device may include an input region, a modulation region, and an output region with respect to the first direction, wherein the modulation region may be arranged between the input region and the output region.

In an embodiment, the electrochromic device may be arranged on the modulation region.

In an embodiment, the cladding layer may include silicon oxide (SiOx), silicon nitride (SiNx), polymethylmethacrylate (PMMA), polyethylene (PE), polypropylene (PP), polystyrene (PS), polycarbonate (PC), cycloolefin copolymer (COC), or a mixture thereof.

In an embodiment, the core layer may include single crystalline silicon, polymethylmethacrylate (PMMA), polyethylene (PE), polypropylene (PP), polystyrene (PS), polycarbonate (PC), cycloolefin copolymer (COC), or a mixture thereof.

In an embodiment, a refractive index of the core layer may be greater than a refractive index of the cladding layer.

In an embodiment, the optical modulator may further include an optical fiber bonded to the core layer.

In an embodiment, the optical modulator may further include pad electrodes arranged spaced apart from and facing each other in a second direction on the optical waveguide device.

In an embodiment, the upper electrode and the lower electrode may include indium tin oxide (ITO), fluorine tin oxide (FTO), antimony tin oxide (ATO), or a mixture thereof.

In an embodiment, the electrolyte layer may include a liquid electrolyte in which metal salt is dissolved in a solvent.

In an embodiment, wherein the metal salt may include lithium perchlorate (LiClO₄), lithium triplate (LiCF₃SO₃), lithium hexafluorophosphate (LiPF₆), lithium bis trifluoromethanesulfonimide (LiTFSI), lithium tetrafluoroborate (LiBF₄), lithium trifluoromethanesulfonyl imide (LiN(CF₃SO₂)₂), lithium hydroxide (LiOH), potassium hydroxide (KOH), sodium hydroxide (NaOH), or a mixture thereof.

In an embodiment, the solvent may include polymethylmethacrylate (PMMA), propylenecarbonate or ethylenecarbonate, polyvinyl alcohol (PVA), polyethylene (PE), polyvinyl acetal, polyamide, polyester, polyether, polylactic acid, polypropylene (PP), polystyrene (PS), or a mixture thereof.

In an embodiment, the electrochromic layer may include tungsten (W), iridium (Ir), nickel (Ni), cobalt (Co), manganese (Mn), niobium (Nb), vanadium (V), indium (In), cerium (Ce), rhodium (Rh), or ruthenium (Ru) oxide.

In an embodiment, the lower electrode and the upper electrode may have a thickness of about 150 nm to about 250 nm, the electrochromic layer may have a thickness of about 200 nm to about 300 nm, and the electrolyte layer may have a thickness of 80 μm to about 200 μm.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 in a perspective view illustrating an optical modulator according to embodiments of the inventive concept;

FIG. 2 is a plan view illustrating an optical modulator according to embodiments of the inventive concept;

FIG. 3 is a cross-sectional view of the optical modulator taken along the line A-A′ of FIG. 2 according to embodiments of the inventive concept;

FIG. 4 is a perspective view illustrating an optical modulator according to embodiments of the inventive concept;

FIGS. 5A and 5B are conceptual diagrams for describing internal ion movement due to application of an electric signal in an optical modulator according to embodiments of the inventive concept;

FIG. 6 is a graph illustrating a change in intensity of output light according to a voltage applied to an optical modulator according to embodiments of the inventive concept;

FIG. 7 is a graph illustrating a change in intensity of output light of an optical modulator due to polarization of incident light according to embodiments of the inventive concept; and

FIG. 8 is a graph illustrating a change in intensity of output light of an optical modulator according to a voltage application time according to embodiments of the inventive concept.

### DETAILED DESCRIPTION

Hereinafter, embodiments of the inventive concept will be described with reference to the accompanying drawings so that the configuration and effects of the inventive concept are sufficiently understood. However, the inventive concept is not limited to the embodiments described below, but may be implemented in various forms and may allow various modifications. Rather, the embodiments are provided so that the disclosure of the inventive concept is thorough and complete and fully conveys the scope of the inventive concept to those skilled in the art.

In this description, when an element is referred to as being ‘on’ another element, it can be directly on the other element, or intervening elements may also be present. In the drawings, the dimensions of elements are exaggerated for clarity of illustration. Like reference numerals refer to like elements throughout. Relational terms such as “first”, “second”, and the like are used in various embodiments of the inventive concept to describe various elements, but the elements should not be limited by the terms. Such terms are merely used to distinguish one element from another element. The embodiments described herein include complementary embodiments thereof.

The terminology used herein is not for delimiting the embodiments of the inventive concept but for describing the embodiments. The terms of a singular form may include plural forms unless otherwise specified. The term “include”, “including”, “comprise” and/or “comprising” used herein does not preclude the presence or addition of one or more other elements.

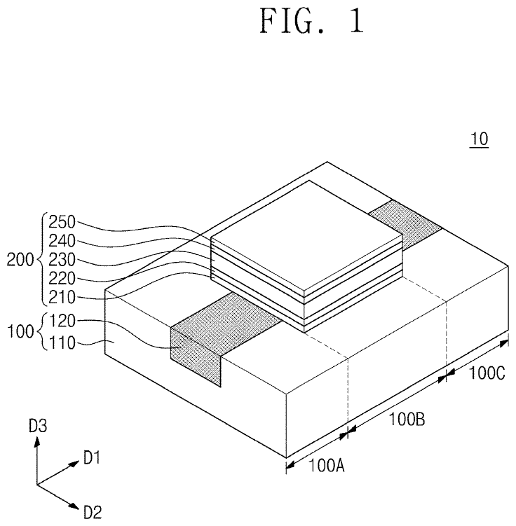

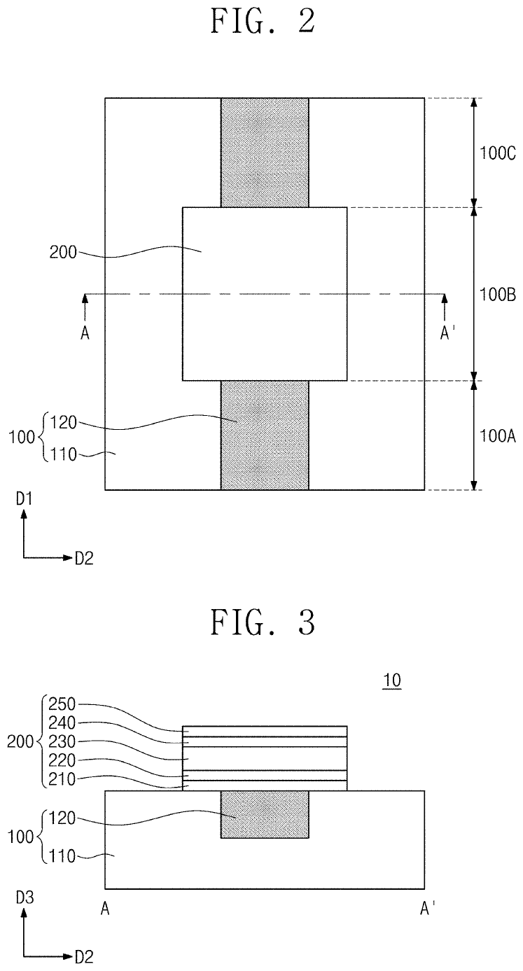

FIGS. 1 and 2 are respectively a perspective view and plan view illustrating an optical modulator 10 according to embodiments of the inventive concept. FIG. 3 is a cross-sectional view of the optical modulator 10 taken along the line A-A′ of FIG. 2.

Referring to FIGS. 1 to 3, the optical modulator 10 may include an optical waveguide device 100 and an electrochromic device 200.

The optical waveguide device 100 may include a cladding layer 110 and a core layer 120.

The cladding layer 110 may include silicon oxide (SiOx), silicon nitride (SiNx), polymethylmethacrylate (PMMA), polyethylene (PE), polypropylene (PP), polystyrene (PS), polycarbonate (PC), cycloolefin copolymer (COC), or a mixture thereof.

The core layer 120 may be formed on the cladding layer 110. The cladding layer 110 may surround a lower surface and side surfaces of the core layer 120. The core layer 120 may extend in a first direction D1. The core layer 120 may include single-crystal silicon, polymethylmethacrylate (PMMA), polyethylene (PE), polypropylene (PP), polystyrene (PS), polycarbonate (PC), cycloolefin copolymer (COC), or a mixture thereof.

For example, a refractive index of the core layer 120 may be greater than that of the cladding layer 110. In the case where the refractive index of the core layer 120 is greater than that of the cladding layer 110, propagation of an optical signal in the optical waveguide device 100 may be facilitated.

The optical waveguide device 100 may be divided into an input region 100A, a modulation region 100B, and an output region 100C with respect to the first direction D1. The modulation region 100B, in which an optical signal is modulated, may be arranged between the input region 100A and the output region 100C. The input region 100A and the output region 100C may be narrower than the modulation region 100B.

The electrochromic device 200 may be arranged on the optical waveguide device 100. For example, the electrochromic device 200 may be arranged on an upper surface of the core layer 120. The electrochromic device 200 may have a layered structure in which a lower electrode 210, an electrochromic layer 220, an electrolyte layer 230, an upper electrode 240, and a substrate 250 are sequentially stacked.

The lower electrode 210 may be formed on the core layer 120, and the upper electrode 240 may be arranged spaced apart from and facing the lower electrode 210. The lower electrode 210 and the upper electrode 240 may include a transparent conductive material such as indium tin oxide (ITO), fluorine tin oxide (FTO), and antimony tin oxide (ATO). For example, the lower electrode 210 and the upper electrode 240 may include ITO. The lower electrode 210 and the upper electrode 240 may have a thickness of about 150 nm to about 250 nm, but the thickness is not particularly limited.

The electrochromic layer 220 may be formed on the lower electrode 210. When an electronic signal is applied to the optical modulator 10, a material included in the electrochromic layer 220 may cause electrochemical oxidation-reduction reaction, and thus transparency and absorbance of the material may reversibly change.

The electrochromic layer 220 may include a material having an electrochromic characteristic that changes the absorbance of the material due to oxidation-reduction reaction, and may include at least one selected from among metal oxides such as tungsten (W), iridium (Ir), nickel (Ni), cobalt (Co), manganese (Mn), niobium (Nb), vanadium (V), indium (In), cerium (Ce), rhodium (Rh), and ruthenium (Ru), organic materials such as viologen, quinone, wurster blue, and perylene dimide, and conductive polymers such as polythiophene, polyaniline, polypyrrole, polyanthracene, polyfluorene, polycarbazole, and polyphenylenevinylene. For example, the electrochromic layer 220 may include metal oxide, and may include tungsten trioxide WO₃. The electrochromic layer 220 may have a thickness of about 200 nm to about 300 nm, but the thickness is not particularly limited.

The electrolyte layer 230 may be formed on the electrochromic layer 220. The electrolyte layer 230 may include a material for inducing oxidation-reduction reaction of electrochromic materials included in the electrochromic layer 220. The electrolyte layer 230 may include a liquid electrolyte, which is, for example, a solvent in which metal salt is dissolved.

The metal salt may include lithium salts such as lithium perchlorate (LiClO₄), lithium triplate (LiCF₃SO₃), lithium hexafluorophosphate (LiPF₆), lithium bis trifluoromethanesulfonimide (LiTFSI), lithium tetrafluoroborate (LiBF₄), lithium trifluoromethanesulfonyl imide (LiN(CF₃SO₂)₂), or lithium hydroxide (LiOH), potassium salts such as potassium hydroxide (KOH), and sodium salts such as sodium hydroxide (NaOH).

The solvent may include at least one selected from among polymethylmethacrylate (PMMA), propylenecarbonate or ethylenecarbonate, polyvinyl alcohol (PVA), polyethylene (PE), polyvinyl acetal, polyamide, polyester, polyether, polylactic acid, polypropylene (PP), and polystyrene (PS).

For example, the electrolyte layer 230 may include an electrolyte in which lithium perchlorate (LiClO₄) is dissolved in a PMMA solvent.

The electrolyte layer 230 may have a thickness of about 80 μm to about 200 μm, but the thickness is not particularly limited.

The substrate 250 may be formed on the upper electrode 240. The substrate 250 may protect the upper electrode 240. The substrate 250 may include transparent glass, fiberglass, or plastic, wherein the plastic may include at least one selected from among polyacrylate, polyethylene ether phthalate, polyethylene naphthalate, polycarbonate, polyarylate, polyetherimide, polyethersulfone, and polyimide. For example, the substrate 250 may include transparent glass.

The optical modulator 10 according to an embodiment of the inventive concept includes the optical waveguide device 100 and the electrochromic device 200 formed on the optical waveguide device 100. An embodiment of the inventive concept provides the optical modulator 10 which has excellent optical modulation efficiency not only for vertical incident light but also for horizontal incident light since the optical modulator 10 includes, on the optical waveguide device 100, the electrochromic device 200 in which the lower electrode 210, the electrochromic layer 220, the electrolyte layer 230, the upper electrode 240, and the substrate 250 are sequentially stacked.

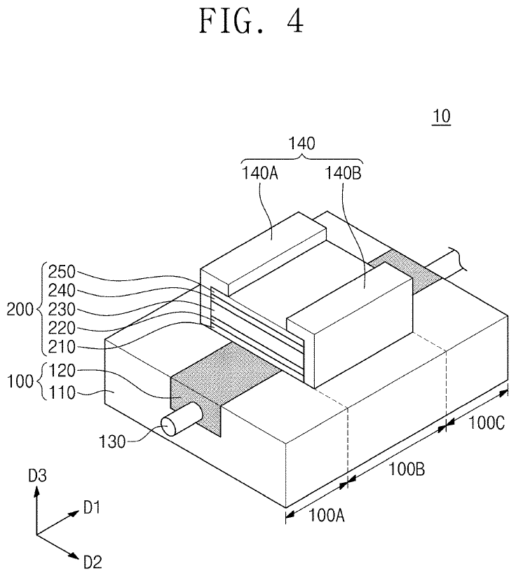

FIG. 4 is a perspective view illustrating an optical modulator according to embodiments of the inventive concept. Descriptions of the optical waveguide 100 and the electrochromic device 200 may be substantially the same as the descriptions provided above with reference to FIGS. 1 to 3. Regarding the present embodiment, detailed descriptions on technical features that overlap with those described above with reference to FIGS. 1 to 3 are not provided, and differences therebetween will be described in detail.

Referring to FIG. 4, the optical waveguide device 100 may be divided into the input region 100A, the modulation region 100B, and the output region 100C with respect to the first direction D1, and an optical fiber 130 may be bonded in the input region 100A and the output region 100C. The optical fiber 130 may be connected to the core layer 120, and may be connected to a sidewall of the core layer 120 in the first direction D1. The optical fiber 130 may provide an optical signal to the core layer 120.

Pad electrodes 140 may be formed on the optical waveguide 100. The pad electrodes 140 may be arranged on the optical waveguide 100 to surround a sidewall of the electrochromic device 200. Pad electrodes 140A and 140B may be arranged spaced apart from and facing each other in a second direction D2 on the optical waveguide 100. Although not illustrated in detail, signal lines may be connected to the pad electrodes 140A and 140B. The signal lines may transfer a pulse signal to the optical waveguide device 100.

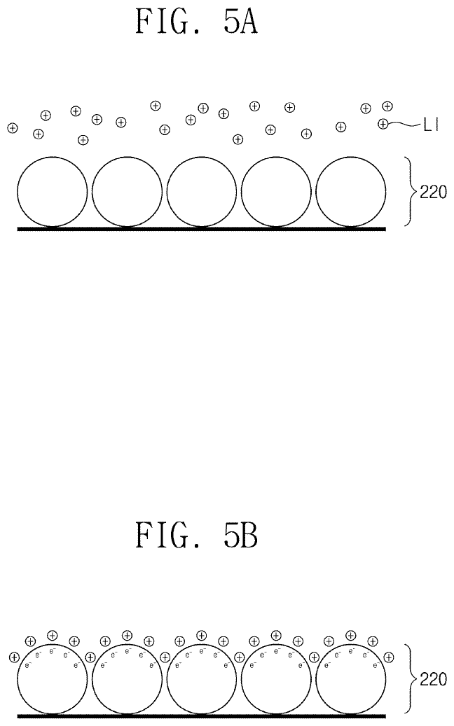

FIGS. 5A and 5B are conceptual diagrams for describing internal ion movement due to application of an electric signal in an optical modulator according to embodiments of the inventive concept.

FIG. 5A illustrates a state in which an electric signal is not applied to the optical modulator 10. As illustrated in FIG. 5A, when an electric signal is not applied, oxidation-reduction reaction do not occur in the electrochromic layer 220, and thus intensity of light does not change.

FIG. 5B illustrates a state in which an electric signal is applied to the optical modulator 10. As illustrated in FIG. 5B, when an electric signal is applied, lithium ions LI in the electrolyte layer 230 move to the electrochromic layer 220 and may induce oxidation-reduction reaction with an electrochromic material included in the electrochromic layer 220. When the lithium ions LI combine with the electrochromic material, propagation of light may be disturbed in the core layer 120, and intensity of output light may reduce. Therefore, an optical light having varying light intensity may be provided by periodically applying an electric signal.

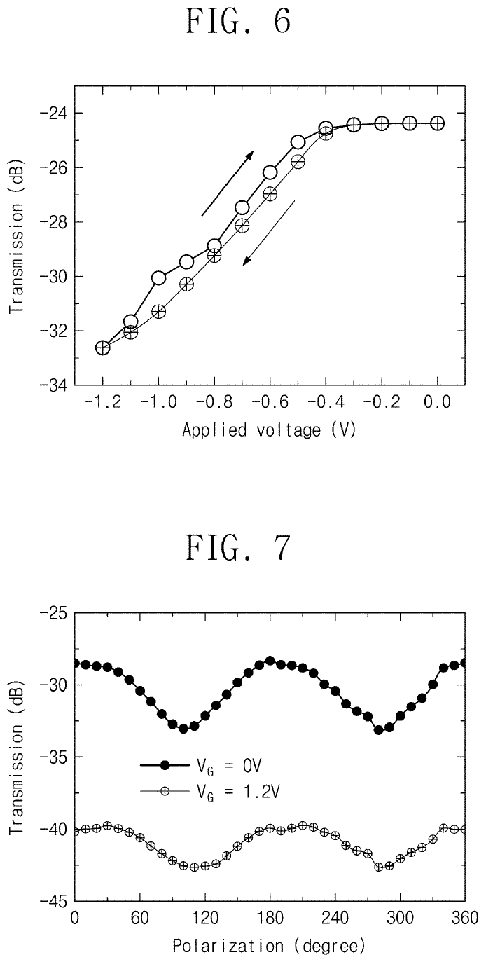

FIG. 6 is a graph illustrating a change in intensity of output light according to a voltage applied to an optical modulator according to embodiments of the inventive concept.

The intensity of output light was measured while varying the voltage applied to the optical modulator within a range of from about 0 V to about −1.2 V. As illustrated in FIG. 6, it may be recognized that the intensity of output light changes when the applied voltage is gradually changed from about 0 V to about −1.2 V and also when the applied voltage is gradually changed from about −1.2 V to about 0 V.

FIG. 7 is a graph illustrating a change in intensity of output light of an optical modulator due to polarization of incident light according to embodiments of the inventive concept.

The change in the intensity of output light due to polarization of incident light was measured when the voltage applied to the optical modulator was changed from about 0 V to about −1.2 V. As illustrated in FIG. 7, it may be recognized that the intensity of output light changes not only for vertical polarization (90°) but also horizontal polarization (0°). In particular, it may be recognized that the optical modulator according to an embodiment of the inventive concept may be used as a horizontal polarization optical modulator since the intensity of output light is higher for horizontal polarization (0°) than for vertical polarization (90°).

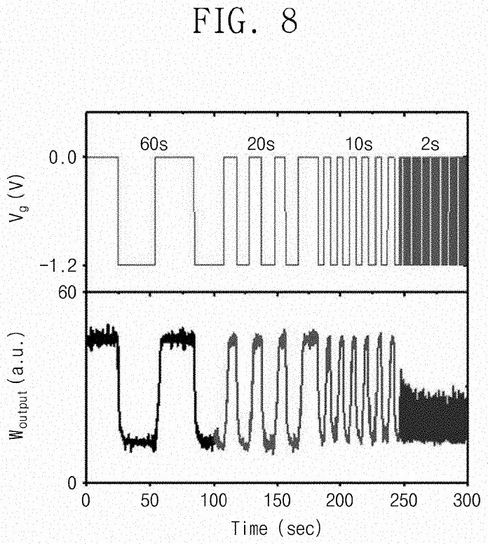

FIG. 8 is a graph illustrating a change in intensity of output light of an optical modulator according to a voltage application time according to embodiments of the inventive concept.

The change in the intensity of output light according to a voltage application time was measured when the voltage applied to the optical modulator was changed from about 0 V to about −1.2 V. As illustrated in FIG. 8, it may be recognized that the intensity of output light is unable to restore an initial state when the voltage application time is very short (at most 2 seconds).

In an optical modulator according to an embodiment of the inventive concept, an optical waveguide device and an electrochromic device are combined, and thus intensity of light passing through a core layer of the optical waveguide device may be modulated. Furthermore, an optical modulator according to an embodiment of the inventive concept is capable of easily modulating intensity of not only vertical incident light but also horizontal incident light.

However, the effects of embodiments of the inventive concept are not limited thereto.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An optical modulator comprising:
an optical waveguide device; and
an electrochromic device on the optical waveguide device,
wherein the optical waveguide device comprises:
a cladding layer; and
a core layer extending in a first direction on the cladding layer, and
wherein the electrochromic device comprises:
a lower electrode on the core layer;
an upper electrode facing the lower electrode;
an electrolyte layer between the lower electrode and the upper electrode; and
an electrochromic layer between the lower electrode and the electrolyte layer.

2. The optical modulator of claim 1,
wherein the optical waveguide device comprises an input region, a modulation region, and an output region with respect to the first direction,
wherein the modulation region is arranged between the input region and the output region.

3. The optical modulator of claim 2, wherein the electrochromic device is arranged on the modulation region.

4. The optical modulator of claim 1, wherein the cladding layer comprises silicon oxide (SiOx), silicon nitride (SiNx), polymethylmethacrylate (PMMA), polyethylene (PE), polypropylene (PP), polystyrene (PS), polycarbonate (PC), cycloolefin copolymer (COC), or a mixture thereof.

5. The optical modulator of claim 1, wherein the core layer comprises single crystalline silicon, polymethylmethacrylate (PMMA), polyethylene (PE), polypropylene (PP), polystyrene (PS), polycarbonate (PC), cycloolefin copolymer (COC), or a mixture thereof.

6. The optical modulator of claim 1, wherein a refractive index of the core layer is greater than a refractive index of the cladding layer.

7. The optical modulator of claim 1, further comprising an optical fiber bonded to the core layer.

8. The optical modulator of claim 1, further comprising pad electrodes arranged spaced apart from and facing each other in a second direction on the optical waveguide device.

9. The optical modulator of claim 1, wherein the upper electrode and the lower electrode comprise indium tin oxide (ITO), fluorine tin oxide (FTO), antimony tin oxide (ATO), or a mixture thereof.

10. The optical modulator of claim 1, wherein the electrolyte layer comprises a liquid electrolyte in which metal salt is dissolved in a solvent.

11. The optical modulator of claim 1, wherein the metal salt comprises lithium perchlorate (LiClO₄), lithium triplate (LiCF₃SO₃), lithium hexafluorophosphate (LiPF₆), lithium bis trifluoromethanesulfonimide (LiTFSI), lithium tetrafluoroborate (LiBF₄), lithium trifluoromethanesulfonyl imide (LiN(CF₃SO₂)₂), lithium hydroxide (LiOH), potassium hydroxide (KOH), sodium hydroxide (NaOH), or a mixture thereof.

12. The optical modulator of claim 10, wherein the solvent comprises polymethylmethacrylate (PMMA), propylenecarbonate or ethylenecarbonate, polyvinyl alcohol (PVA), polyethylene (PE), polyvinyl acetal, polyamide, polyester, polyether, polylactic acid, polypropylene (PP), polystyrene (PS), or a mixture thereof.

13. The optical modulator of claim 1, wherein the electrochromic layer comprises tungsten (W), iridium (Ir), nickel (Ni), cobalt (Co), manganese (Mn), niobium (Nb), vanadium (V), indium (In), cerium (Ce), rhodium (Rh), or ruthenium (Ru) oxide.

14. The optical modulator of claim 1, wherein the lower electrode and the upper electrode have a thickness of about 150 nm to about 250 nm, the electrochromic layer has a thickness of about 200 nm to about 300 nm, and the electrolyte layer has a thickness of 80 μm to about 200 μm.
